(19) United States
(12) Patent Application Publication
(10) Pub. No.: US 2024/0064204 A1
(43) Pub. Date: Feb. 22, 2024

(54) SYSTEM ARCHITECTURE FOR IoT SPECTROSCOPY

(71) Applicant: SENORICS GMBH, Dresden (DE)

(72) Inventors: Rick-Rainer LUDWIG, Dresden (DE); Matthias JAHNEL, Dresden (DE)

(73) Assignee: SENORICS GMBH, Dresden (DE)

(21) Appl. No.: 18/260,584

(22) PCT Filed: Jan. 25, 2022
(86) PCT No.: PCT/EP2022/051533

§ 371 Date: Jul. 6, 2023

(30) Foreign Application Priority Data
Jan. 27, 2021 (DE) 10 2021 101 777.7

(51) Int. Cl. H04L 67/12; G01J 3/28; G01J 3/02; G16Y 40/35; G16Y 20/10; G16Y 10/90

(52) U.S. Cl. CPC H04L 67/12; G01J 3/28; G01J 3/0264; G16Y 40/35; G16Y 20/10; G16Y 10/90; G01J 2003/283

(57) ABSTRACT

A system architecture for a measurement data processing system specifically designed under the aspect of application in an Internet of Things device is presented. The disclosed system is particularly well suited for application to spectroscopy. The measurement data processing system (1) comprises at least one measuring device (2), comprising an embedded operating system (22), accessing and being accessible by a remote instrument backend (3), and a user device with a user accessible application (51), accessing and being accessible by a remote application backend (6), wherein the instrument backend (3) and the application backend (6) are cloud-based, and wherein the instrument backend (3) and the application backend (6) are set up to make use of cloud computing resources to store and retrieve and process data.

The present invention relates to a measurement data processing system, especially concerning the system architecture thereof, and its use.

An application of this invention includes the optimized adaptation of spectroscopy to the Internet of Things (IoT).

The advent of miniaturized, lightweight, robust and customizable solutions instead of the hitherto bulky and sensitive lab spectrometers has brought spectroscopy within reach of a new non-expert user community and of widespread adoption of such spectrometers for on-site measurements in everyday-life applications. A further step forward is the application of spectroscopy within the frame of the Internet-of-Things (IoT), e.g. in smart appliances like smart refrigerators or smart washing machines, smart living environments, smart farming, smart wearables, etc., wherein IoT can be understood as an approach for networking physical objects to collect and exchange data. IoT approaches usually comprise that devices are given a unique address in a network and are equipped with electronic intelligence. This enables them to communicate via the Internet and to perform tasks fully automatically. In addition to the possibility of communication between the devices (machine-to-machine communication, M2M), many of the networked objects provide an interface via the Internet, through which the devices can be operated and controlled by a user from any location.

Photodetectors based on organic materials are especially well suited for an application of spectroscopy in IoT, as they are small, lightweight and inexpensive. Such a photodetector is disclosed in EP 3 152 785 B1.

Software for use in the context of IoT should fulfil several requirements, mostly resulting from potentially constrained hardware, the demand for these systems to work autonomously and the usability of the system from a developer's perspective. By way of example, the memory requirement of the software employed in conjunction with IoT should be very low, as well as the complexity of operations and the power consumption.

U.S. Pat. No. 10,323,982 B2 discloses a compact spectrometer system comprising a local processing unit configured to convert the raw spectral data into processed spectral intensity and a communication module configured to be in communication with the local processing unit and a remote processing unit, wherein the communication module is configured to transmit the processed spectral intensity data from the local processing unit to the remote processing unit, and wherein the remote processing unit is configured to generate the spectrum of the sample in response to the processed spectral intensity. The remote processing unit may comprise a database of spectral information, the spectral information comprising e.g. raw detector data, pre-processed detector data, or post-processed detector data.

The system as disclosed in U.S. Pat. No. 10,323,982 B2, having a local processing unit which processes the spectral intensity data, does not fulfil the above-mentioned requirements and is thus not suitable for IoT applications.

CN 109 270 024 A describes a wireless data acquisition system for a near-infrared spectrometer based on narrowband (NB)-IoT. The system comprises a spectrometer module, a main control module, an NB-IoT wireless communication module, an operator data transmission network, an IoT cloud server and a mobile terminal module. A spectrometer module, a main control module and an NB-IoT wireless communication module form a system to complete near-infrared spectrum data acquisition, module positioning and data uploading. The spectrometer module is a near-infrared miniaturized indium gallium arsenide array spectrometer, which can perform spectral or diffuse reflectance spectroscopy measurements and obtain spectral data. The main control module is configured to control the working state of the spectrometer module, and upload the spectrometer module number, working parameters, and collected spectral data to the IoT cloud server through the NB-IoT wireless communication module and an operator data transmission network. The IoT cloud server completes data analysis, storage and release. Query service is provided for the user through the mobile terminal module. The disclosure does not provide a solution for connecting several devices and thus allowing joint control. Furthermore, it does not disclose how a cooperation of different parties and worldwide exchange of data with distinct authorisation could take place.

An IoT-related device based in the cloud needs to be provisioned with distinct credentials that allow to uniquely identify the device. Techniques for provisioning an IoT device with such device-specific credentials via a cloud computing platform are disclosed in U.S. Pat. No. 10,447,683 B1.

The present invention seeks to provide a system presenting an option for a measurement data processing system specifically designed under the aspect of application in an IoT device.

The invention provides a measurement data processing system, comprising at least one measuring device, which comprises an embedded operating system, and which accesses and is accessible by a remote instrument backend; a user device with a user-accessible application, which accesses and is accessible by a remote application backend; wherein the remote instrument backend and the remote application backend are cloud-based, and wherein the instrument backend and the application backend make use of cloud-computing resources to store and retrieve and process data.

The measuring device may not make use of local data storage, retrieval and/or processing resources. Alternatively, the measuring device may have local resources, at least for data storage and retrieval. For example, the measuring device may be configured to be able to measure autonomously without being connected to the cloud. The measuring device may then be able to buffer raw measurement data locally. Once the measuring device is connected to the cloud, the raw measurement data can be transferred via the instrument backend to the cloud-computing resources and be processed by them.

The embedded operating system of the measuring device is to be understood as an IoT enabling operating system, which is optimized for use in conjunction with the IoT. The embedded operating system interacts with the cloud-based instrument backend via a communication protocol, such as for example, but not limited to, http, https, WebSocket etc.

The user-accessible application may be a single-page application, which interacts dynamically with the application backend using a communication protocol, such as for example, but not limited to, http, https, WebSocket, etc. Alternatively, the user-accessible application may be multi-page application.

By consistently relocating resources as much as possible to the cloud, the measurement data processing system is advantageously adapted to the measuring device and/or the user device being implemented in an IoT device.

It is understood that it also falls within the scope of this invention for the user device and/or the measuring device not to be implemented in an IoT device; for only the user device to be implemented in an IoT device; for only the measuring device to be implemented in an IoT device; for both the user device and the measuring device to be implemented in separate IoT devices; for both the user device and the measuring device to be implemented in the same IoT device.

In the context of the invention, the term “data” may comprise measurement data and/or metadata, metadata being understood as any kind of data providing information about the measurement data, e.g. time and/or date and/or location of creation of the measurement data, a unique identification of the measuring device the measurement data has been taken with, a classification of the sample the measurement data has been taken on, an analyte and the matrix or matrices in which it may be embedded in the sample, reference values for analyte and/or matrix, etc.

In an embodiment of the measurement data processing system, the measuring device is of spectrometer-type. The spectrometer-type instrument may generate spectral data as measurement data. The spectrometer-type instrument may additionally include various sensors, such that it may additionally generate non-spectral data, e.g. data on temperature, pressure, humidity, flow rate of a liquid, etc.

In the context of the invention, a spectrometer is understood to be a device capable of probing a property, e.g. the intensity or the radiant flux, of electromagnetic radiation at several different wavelengths of radiation, e.g. in the visible range or in the infrared range. The probing may take place after interaction of the radiation with a sample to be analyzed. The working principle of the spectrometer may be based on converting radiation absorbed in the spectrometer's detection unit to electric current.

In the context of the invention, spectral data is understood to be any data qualitatively or quantitatively relating a property of electromagnetic radiation at several different wavelengths of the radiation to the interaction of the radiation with a sample to be analyzed. For example, spectral data may be an electric current at different wavelengths of electromagnetic radiation, wherein the electric current is generated in a detection unit of the spectrometer by absorption of electromagnetic radiation of the respective wavelength, after the radiation was in interaction, e.g. was absorbed or reflected or transmitted, with the sample to be analyzed.

Preferably, the electromagnetic radiation employed by the spectrometer may be in the visible (wavelength of ca. 400 to ca. 700 nm) and/or near infra-red range (NIR) (ca. 700 nm to ca. 2500 nm). In particular, NIR spectroscopy offers many advantages, such as e.g. requiring little or no sample preparation, being non-destructive and/or the possibility of fast data acquisition. Excitation by radiation in the NIR range may correspond to high energy vibrational transitions in the material to be analyzed, e.g. molecular vibrations of hydrogen bonds. These transitions may result in spectral bands which are highly overlapped. NIR spectral data contain a great quantity of chemical and physical information, which may make it difficult to link the spectral data to the relevant information. Thus, for interpretation of NIR spectral data, some kind of referencing, also termed calibration, may be necessary to correlate spectral data obtained during calibration measurements on reference samples with confirmed reference values of a certain property of a sample to be analyzed.

In a further embodiment of the measurement data processing system the instrument backend and the application backend access and are accessible by a remote spectroscopy platform, wherein the spectroscopy platform is cloud-based. The spectroscopy platform may comprise databases and compute services to store and retrieve and process spectral data gathered by the spectrometer-type measuring device.

The spectroscopy platform may provide the databases and compute services necessary to extract information about the sample to be analyzed from the measurement data. The spectroscopy platform may provide calibration models.

The outsourcing of the spectroscopy platform to the cloud instead of providing computing capacity on a local platform coupled to the spectrometer advantageously reduces, among others, memory requirements and power consumption of the measuring device as compared to conventional spectrometers.

The spectroscopy platform may be set up to compare measured spectral data against a reference spectrum of a known substance to identify the wanted property of the sample to be analyzed.

Preferably, the spectroscopy platform may be set up to apply chemometric methods to the spectral data gathered by the spectrometer-type measuring device.

Chemometric methods produce statistical models to classify and/or quantify at least one property of the material to be analyzed from the spectral data. Such methods, e.g. algorithms, may comprise mathematical pretreatment of the data, e.g. smoothing and/or scatter correction, and analysis tools, e.g., but not limited to, partial least squares, principal component analysis, multivariate regression, machine-learning techniques like the Support Vector Machine, soft independent modeling of class analogy, etc. The algorithms have to be trained on the basis of reference data measured on well-characterized reference samples.

The application of chemometric models enables the extraction of wanted information from highly correlated spectral data of hitherto uncharacterized samples.

Preferably, the spectroscopy platform is set up to provide trained algorithms that relate a multivariate response of the spectrometer-type measuring device to at least one qualitative and/or quantitative property of a hitherto uncharacterized sample.

According to another embodiment, the measurement data processing system comprises several measuring devices, e.g. two or more measuring devices, one of which is a primary measuring device controlling at least one secondary measuring device.

Preferably, the primary measuring device may be the only one of those several measuring devices which communicates with the remote instrument backend. The secondary measuring devices may be coupled to the primary device, exchanging data with the primary device, but not with the instrument backend. The several measuring devices may communicate with each other via classic Bluetooth, BLE, etc. For example, a secondary measuring device may communicate with the primary measuring device via classic Bluetooth or BLE.

Advantageously, the at least one secondary measuring device may accomplish measurements at a wavelength range different from the one the primary measuring device is designed for. The at least one secondary measuring device may alternatively or additionally accomplish measurements at an arrangement different from the arrangement of the primary measuring device. By way of example, the primary measuring device may detect electromagnetic radiation transmitted through the sample to be analyzed, and the at least one secondary measuring device may detect electromagnetic radiation reflected by the sample to be analyzed. The person skilled in the art will appreciate that other configurations and designs of measuring devices known to the person skilled in the art may be applied.

The provisioning of more than one measuring device allows for a variety of measurement configurations, and thus allows to obtain more or more substantiated information on the sample to be analyzed.

In a further embodiment, the remote instrument backend of the measurement data processing system provides at least one interface to enable bidirectional synchronous and/or asynchronous communication between the instrument backend and the measuring device.

Advantageously, the bidirectionality ensures that the measuring device may be controlled and that data, e.g. status information of the measuring device, may be sent to the instrument backend without query.

In a further embodiment, the remote instrument backend of the measurement data processing system supports asymmetric encryption capabilities to identify the measuring device and encrypts communication between the instrument backend and the measuring device.

Among others, the identification of the measuring device advantageously may allow the spectrometer-type measuring device to be assigned a unique calibration.

According to another embodiment, the application backend of the measurement data processing system is set up to enable the user to assign sample information and/or reference values to measurement data. Specifically, the user may be able to assign information which is needed to apply chemometric models to the measurement data. This information may concern e.g., but not limited to, analytes, matrices the analytes is embedded in, reference values for analytes and/or matrices, etc.

Throughout this description, the term “at least one” is used for the sake of brevity, which can mean: one, exactly one, several (e.g. exactly two, or more than two), many (e.g. exactly three or more than three), etc. However, “several” or “many” does not necessarily mean that there are several or many identical elements, but several or many essentially functionally identical elements.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination.

The following detailed description of an exemplary embodiment of the invention is presented to enable any person skilled in the art to make and use the disclosed subject matter in the context of one or more particular implementations. Various modifications to the disclosed implementation will be readily apparent to those skilled in the art, and the general principles defined herein may be applied to other implementations and applications without departing from the scope of the disclosure. Thus, the present disclosure is not intended to be limited to the described or illustrated implementations, but is to be accorded the widest scope consistent with the principles and features disclosed herein.

Implementations of the invention will be described, by way of example only, with reference to the accompanying drawing in which:

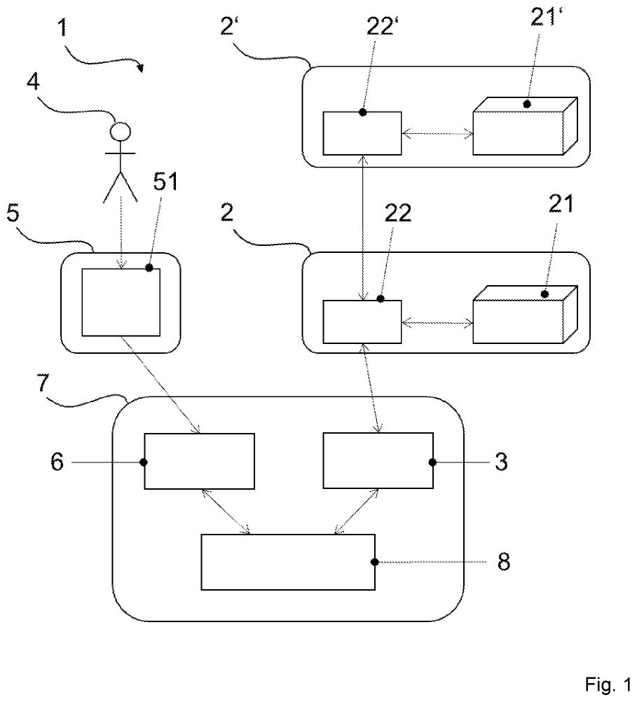

FIG. 1 schematically shows the architecture of a measurement data processing system 1 according to the invention. The embodiment comprises two spectrometer-type measuring devices 2, 2′ associated with at least one IoT device. The two spectrometer-type measuring devices 2, 2′ each comprise a detector 21, 21′ and are operated by an embedded operating system 22, 22′, which is optimized for application in the IoT. One of the two measuring devices is the primary measuring device 2 which uses a remote instrument backend 3 via https and/or WebSocket. The other measuring device is a secondary measuring device 2′ which is only coupled to the primary measuring device 2, but not directly to the instrument backend 3. The user 4 may enter information, queries and/or commands into a single-page application 51 in a web browser 5 on his user device, which uses a remote application backend 6 via https and/or WebSocket. The instrument backend 3 and the application backend 6 are based in the cloud 7. The instrument backend 3 and the application backend 6 access and are accessed by a remote spectroscopy platform 8 which is also cloud-based. There is no desktop application on a local platform associated to the user 4, and no local processing unit for spectral data.

### LIST OF REFERENCES

1 Measurement data processing system
2 Primary measuring device
2′ Secondary measuring device
21 Detector of the primary measuring device
21′ Detector of the secondary measuring device
22 Embedded operating system of the primary measuring device
22′ Embedded operating system of the secondary measuring device
3 Instrument backend
4 User
5 Web browser
51 Single-page application
6 Application backend
7 Cloud
8 Spectroscopy platform

1. A measurement data processing system (1), having
at least one measuring device (2), comprising an embedded operating system (22), accessing and being accessible by a remote instrument backend (3); and
a user device with a user accessible application (51), accessing and being accessible by a remote application backend (6);
wherein the instrument backend (3) and the application backend (6) are cloud-based, and wherein the instrument backend (3) and the application backend (6) are set up to make use of cloud computing resources to store and retrieve and process data.

2. The measurement data processing system (1) according to claim 1, wherein the measuring device (2, 2′) is of spectrometer-type, generating spectral data.

3. The measurement data processing system (1) according to claim 2, wherein the instrument backend (3) and the application backend (6) access and are accessible by a remote spectroscopy platform (8), wherein the spectroscopy platform (8) is cloud-based, and wherein the spectroscopy platform (8) comprises databases and compute services to store and retrieve and process spectral data gathered by the measuring device (2).

4. The measurement data processing system (1) according to claim 3, wherein the spectroscopy platform (8) is set up to apply chemometric methods to the spectral data.

5. The measurement data processing system (1) according to claim 4, wherein the spectroscopy platform (8) is set up to provide trained algorithms that relate a multivariate response of the measuring device (2) to the qualitative and/or quantitative properties of a hitherto uncharacterized sample.

6. The measurement data processing system (1) according to claim 1, wherein the measurement data processing system (1) has several measuring devices (2, 2′), one of which is a primary measuring device (2) controlling at least one secondary measuring device (2′).

7. The measurement data processing system (1) according to claim 6, wherein only the primary measuring device (2) accesses and is accessible by the instrument backend (3).

8. The measurement data processing system (1) according to claim 1, wherein the instrument backend (3) provides at least one interface to enable bidirectional synchronous and/or asynchronous communication between the instrument backend (3) and the measuring device (2).

9. The measurement data processing system (1) according to claim 1, wherein the instrument backend (3) supports asymmetric encryption capabilities to identify the measuring device (2) and encrypts communication between the instrument backend (3) and the measuring device (2).

10. The measurement data processing system (1) according to any one of the preceding claim 1, wherein the instrument backend (3) provides services based on protocols.

11. The measurement data processing system (1) according to claim 1, wherein the application backend (6) is set up to enable a user (4) to assign sample information and/or reference values to measurement data via the user accessible application (51).

12. The measurement data processing system (1) according to claim 2, wherein the measurement data processing system (1) has several measuring devices (2, 2′), one of which is a primary measuring device (2) controlling at least one secondary measuring device (2′).

13. The measurement data processing system (1) according to claim 3, wherein the measurement data processing system (1) has several measuring devices (2, 2′), one of which is a primary measuring device (2) controlling at least one secondary measuring device (2′).

14. The measurement data processing system (1) according to claim 4, wherein the measurement data processing system (1) has several measuring devices (2, 2′), one of which is a primary measuring device (2) controlling at least one secondary measuring device (2′).

15. The measurement data processing system (1) according to claim 5, wherein the measurement data processing system (1) has several measuring devices (2, 2′), one of which is a primary measuring device (2) controlling at least one secondary measuring device (2′).

16. The measurement data processing system (1) according to claim 15, wherein only the primary measuring device (2) accesses and is accessible by the instrument backend (3).

17. The measurement data processing system (1) according to claim 16, wherein the instrument backend (3) provides at least one interface to enable bidirectional synchronous and/or asynchronous communication between the instrument backend (3) and the measuring device (2).

18. The measurement data processing system (1) according to claim 17, wherein the instrument backend (3) supports asymmetric encryption capabilities to identify the measuring device (2) and encrypts communication between the instrument backend (3) and the measuring device (2).

19. The measurement data processing system (1) according to claim 18, wherein the instrument backend (3) provides services based on protocols.

20. The measurement data processing system (1) according to claim 19, wherein the application backend (6) is set up to enable a user (4) to assign sample information and/or reference values to measurement data via the user accessible application (51).
